(19) United States
(12) Patent Application Publication
(10) Pub. No.: US 2022/0362871 A1
(43) Pub. Date: Nov. 17, 2022

(54) ELECTROLYSIS DEVICE

(71) Applicant: National Yunlin University of Science and Technology, Yunlin (TW)

(72) Inventor: Chia-Lung Kuo, Yunlin (TW)

(21) Appl. No.: 17/742,062

(22) Filed: May 11, 2022

(30) Foreign Application Priority Data
May 13, 2021 (TW) 110117383

(51) Int. Cl. B23H 1/08; B23H 1/10

(52) U.S. Cl. CPC B23H 1/08; B23H 1/10

(57) ABSTRACT

The present invention provides an electrical discharge machining device comprising a first injection flow generating device and a wire electrode. The first injection flow generating device comprises an injection head having a nozzle and a flow channel communicated with the nozzle. The flow channel is utilized to guide a first flow injected from the nozzle, wherein the first flow comprises a first phase flow and a second phase flow. The wire electrode is coupled to the nozzle for receiving the first flow injected from the nozzle.

This application claims the benefit of Taiwan Patent Application Serial No. 110117383, filed May 13, 2021, the subject matter of which is incorporated herein by reference.

### BACKGROUND OF INVENTION

### 1. Field of the Invention

The present invention relates to an electrical discharge machining (EDM) technology, and more particularly, to an electrical discharge machining device having injection flow during the electrical discharge machining process whereby the machining efficiency for forming deep hole and slot can be enhanced and the roughness of the forming structure can be greatly improved.

### 2. Description of the Prior Art

With the great advance of the machining technology, the miniaturization of manufacturing components or parts is greatly required in each industrial field, in which the micro hole structures play a vital role in the miniaturized components or parts. Nevertheless the micro hole structures can be broadly applied in different industrial field, especially in aerospace industry, biotechnology industry, optical semiconductor industry and medical and health industry, the issues that how to effectively control the roughness and machining precision of the machining object will affect the evolution of the machining process.

The drilling EDM is a main machining device for forming tiny or deep holes having high aspect ratio. The drilling EDM comprises a chuck coupled to the main spindle for holding and rotating the tubular electrode. Through the rotating the tubular electrode, the tubular electrode further injects the high-pressure machining fluid and is energized to performing EDM process on the object whereby a plurality of tiny holes and deep holes can be formed on the object.

Please refer to the FIG. 1, which illustrates a conventional drilling EDM device. One end of the wire electrode 10 is held by the rotating chunk 11 while the other end passes through the diamond die 12 arranged below the spindle. During the machining process for forming the hole structures on the object, the wire electrode 10 having hollow tube is adapted, and the machining fluid, e.g. water for example, passing through the hollow channel is pressurized through the pipelines and then is forced into the tubular electrode thereby generating injection flow for providing lubricant effect and discharging the machining debris or waste during the EDM processing.

Conventionally, since the diameter of the tubular electrode is getting smaller, such as the outer diameter around 0.1 mm, and inner diameter 0.035 mm, using the conventional pressure pump for increasing the machining fluid pressure can not effectively pump the machining fluid into the hollow channel of the tubular electrode so that the machining efficiency of the drilling EDM process will be greatly reduced.

Accordingly, there has a need for providing a totally new design of the EDM device for solving the problem occurred in the conventional art.

### SUMMARY OF THE INVENTION

The present invention provides an electrical discharge machining device having an injection device for injecting the machining fluid into the hollow channel of the wire electrode such that the efficiency of discharging debris as well as the lubricant effects during the drilling EDM process for forming the tiny holes or deep holes can be greatly improved. In addition, the EDM device further comprises double layered fluid bearing structure for guiding the fluid, such as liquid, or mixed fluid having liquid and gas, or mixed fluid having bubbles, liquid and granular objects, to contact with the wire electrode thereby preventing the rotating wire electrode from contacting with the fluid bearing, i.e. diamond dies, so as to reduce the electrode abrasion and vibration during the drilling EDM process. Moreover, through the design of the present invention, when deep holes or tiny holes having different size are processed, it is not necessary to replace the diamond dies having different dimension such that the problem of non-automation and low machining efficiency caused by stopping the EDM machining device when the diamond dies has to be changed can be effectively avoided.

In the embodiment of the present invention, the injection flow generating device injecting a mixed fluid having gas phase and liquid phase into the hollow channel of the wire electrode through the injection head whereby the wire electrode can effectively inject the mixed fluid into the machining position during machining the tiny holes or deep holes thereby achieving the effects of lubricant and discharging debris. In one embodiment, through different volume fraction of the liquid phase and gas phase, a two-phase fluid having liquid spray or micro gas bubbles can be generated whereby the two-phase fluid can passes through the hollow channel of the wire electrode more smoothly and easily thereby improving the machining effect. It is noted that according to the Hagne-Poiseuille's equation listed as equation (1) shown below, the ΔP represents the pressure loss, L represents length of the thin tube, μ represents dynamic viscosity, Q represents volume flow rate, r represents radius, and ΔP is inversely proportional to the fourth power of radius r and is proportional to the dynamic viscosity μ.

$$Δ P = \frac{8 μ LQ}{π {r}^{4}} \qquad ( 1 )$$

It is noted that the viscosity of the pure water (0.8 mPa-s) is 44 times of the air viscosity (18 μPa-s); therefore, when the micro scale or nano scale air bubbles are mixed into the liquid, it is capable of reducing the dynamic viscosity μ and reducing the pressure loss ΔP. Furthermore, the friction force between the machining fluid and the inner wall of the diamond dies can be reduced by reducing the dynamic viscosity μ thereby reducing the abrasion of the diamond dies such that not only can the cost of the diamond dies can be effectively lowered and the machining precision and efficiency can also be enhanced.

The present invention provides an electrical discharge machining device in which a plurality of buffer channels are equiangularly and symmetrically arranged around the main body of the injection head and are communicated with a flow channel inside the injection head and communicated with the external environment. The buffer channels are utilized to guide the external gas into the flow channel by the negative pressure generated from the high-speed injected first flow in the flow channel, wherein the drawn gas is capable of exerting acting force onto the wire electrode so as to keep the wire electrode stable without vibration thereby improving the precision of the machining process.

In one embodiment, the present invention provides an electrical discharge machining device, comprising an injection flow generating device, an electrode clamping structure, and an electrode guiding device. The injection flow generating device comprises an injection head having a nozzle and a flow channel communicated with the nozzle, wherein the flow channel is utilized to guide a first flow injected from the nozzle, wherein the first flow comprises a first phase flow and a second phase flow. The wire electrode is coupled to the nozzle for receiving the first flow injected from the nozzle. The electrode clamping structure is configured to clamp the wire electrode and to rotate the wire electrode. The electrode guiding device is arranged at one side of the electrode clamping structure for guiding the wire electrode.

### BRIEF DESCRIPTION OF THE DRAWINGS

The present invention will now be specified with reference to its preferred embodiment illustrated in the drawings, in which:

FIG. 1 illustrates a conventional electrical discharge machining device;

FIGS. 2A˜2D respectively illustrate different embodiments with respect to the injection flow generating device of the present invention;

FIGS. 3A˜3D respectively illustrate different embodiments with respect to electrical discharge machining device of the present invention;

FIG. 4 illustrates the electrode guiding device according to one embodiment of the present invention;

FIG. 5A illustrates a top view of the first flow bearing according to one embodiment of the present invention;

FIG. 5B illustrates a top view of the first flow bearing according to another embodiment of the present invention;

FIG. 5C illustrates a top view of the first flow bearing according to one further embodiment of the present invention;

FIG. 6 illustrates AA cross sectional view of the electrode guiding device according to one embodiment of the present invention;

FIGS. 7A˜7D respectively illustrate a first and a second guiding channels arranged inside the first and second flow bearing according to different embodiments of the present invention;

FIG. 8 illustrates a cross sectional view of the guiding device according to one embodiment of the present invention;

FIGS. 9A˜9C respectively illustrate electrical discharge machining device according to different embodiments of the present invention;

FIG. 10A illustrates injection flow generating device according to another embodiment of the present invention;

FIGS. 10B˜10C illustrates control signal according to one embodiment of the present invention; and

FIGS. 11A˜11B respectively illustrate injection flow generating device according to different embodiments of the present invention.

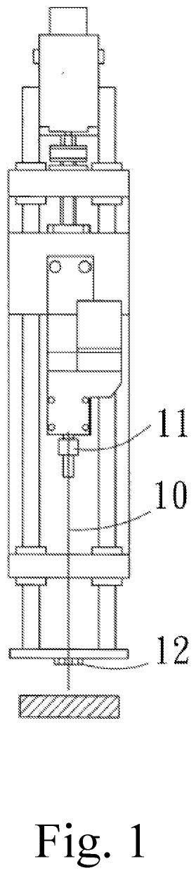

### DESCRIPTION OF THE PREFERRED EMBODIMENT

The invention disclosed herein is directed to an electrical discharging machining device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

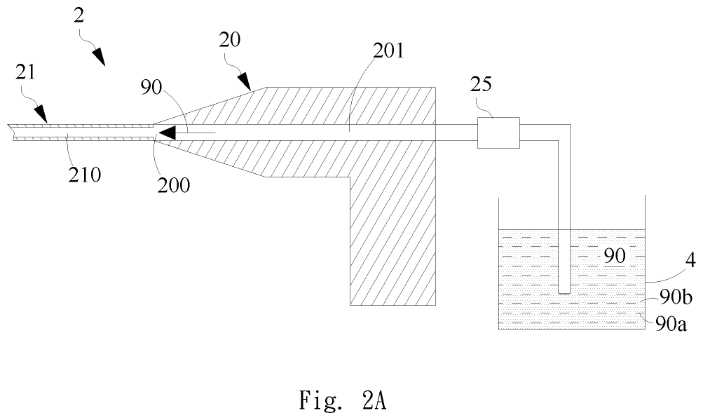

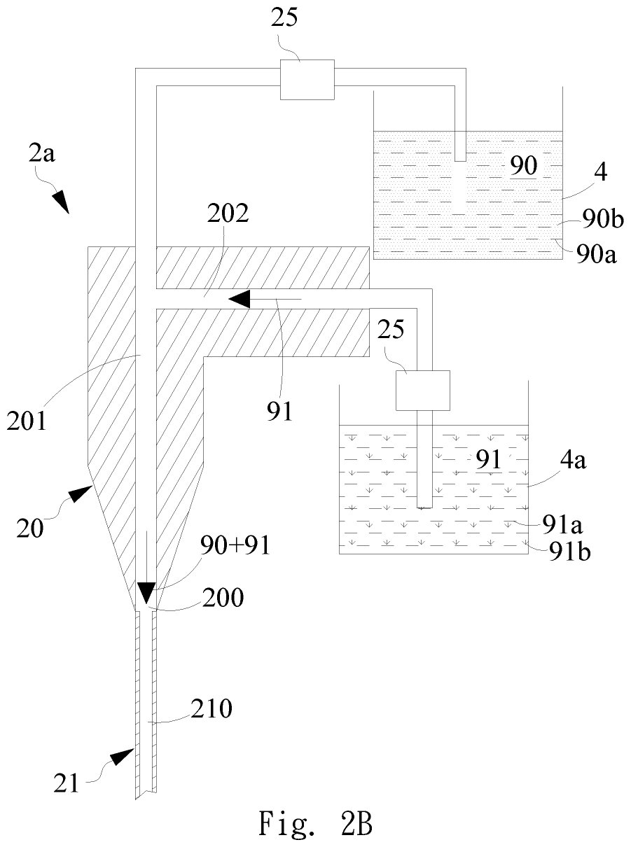

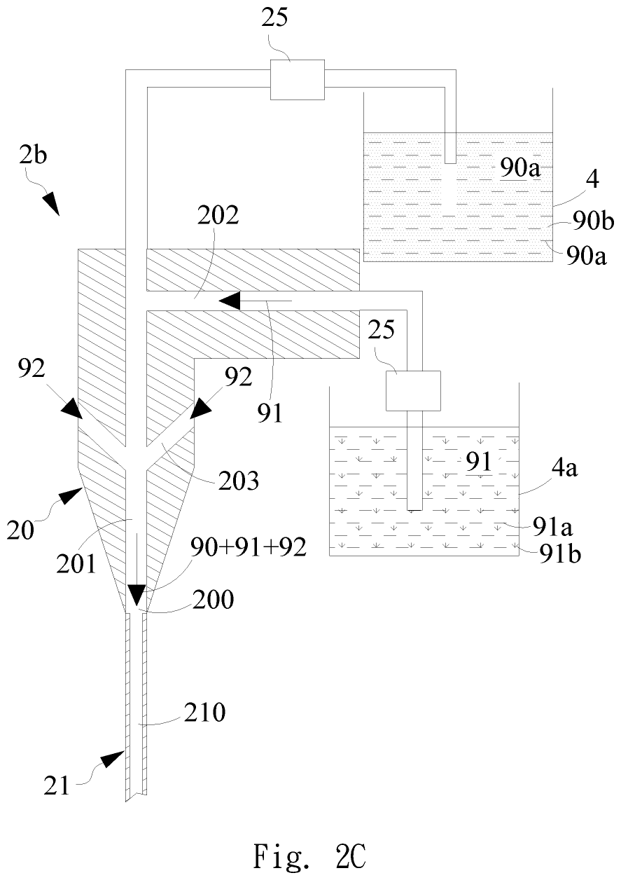

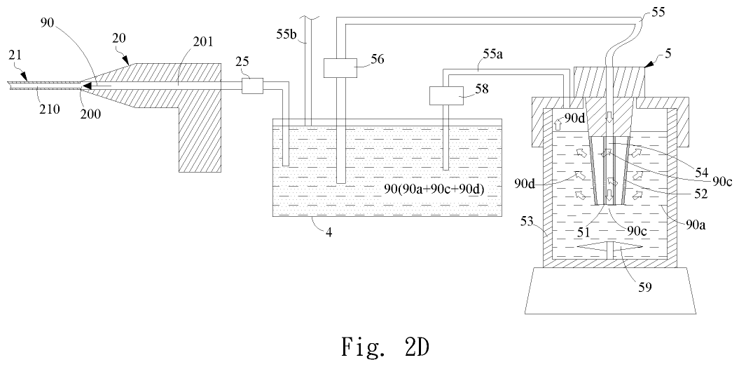

Please refer to FIG. 2A, which illustrates the injection flow generating device according to one embodiment of the present invention. The injection flow generating device 2 comprises an injection head 20 and a wire electrode 21. The injection head 20 comprises a nozzle 200 and a flow channel 201 arranged inside the injection head 20 and communicated with the nozzle 200, wherein the flow channel 201 is configured to guide a first flow 90 injected from the nozzle 200. In the present embodiment, the first flow 90 comprises a first phase flow and a second phase flow. In one embodiment, the first flow 90 has a plurality of bubbles having micro scale or nano scale contained therein. The first phase flow 90a is a liquid (shown as dashed line in FIG. 2A) and the second phase flow 90b is gas shown as dots in FIG. 2A wherein the liquid can be, but should not be limited to, water or oil. In the present embodiment, the volumn fraction of first phase flow 90a is around 90˜95%, and the volumn fraction of the second phase flow 90b is around 5˜10%. Alternatively, the first flow 90 is atomized flow in which the first phase flow 90a is a liquid having volumn fraction 5˜10% and the second phase flow 90b is gas having volumn fraction 90˜95%.

The wire electrode 21 is configured to receive the first flow 90 injected from the nozzle 200. In the present embodiment, the wire electrode 21 is connected to the nozzle 200, wherein the wire electrode 21 has a hollow channel 210 for guiding the first flow 90 injected from the nozzle 200. The wire electrode 21 is a tubular electrode having the hollow channel 210. The material for making the wire electrode 21 can be, but should not be limited to, copper. In one embodiment, the diameter of the wire electrode 21 can be ranged, but should not be limited, between 0.3 mm˜1 mm. In the embodiment shown in FIG. 2A, the first flow 90 is provided by the liquid tank 4 wherein the first flow 90 is pumped by the pumping device 25 from the liquid tank 4 to the nozzle 200 of the injection head 20 through pipelines. It is noted that the second phase flow 90b can also be flammable gas, such as hydrogen, ammonia, natural gas, methane, or ethane. Alternatively, the second phase flow 90b can also be combustion gas, such as oxygen, for example. In addition, the second phase flow 90b can also be a combination of flammable gas and combustion gas. The mixed flammable gas and combustion gas is mixed with the first phase flow 90a so that when the electrical discharge machining process is performed on the object the second phase flow 90b can be burned to emitted heat. The emitted heat during the machining process can help to improve the cutting or drilling efficiency during the electrical discharge machining process. Moreover, it is noted that when the second phase flow 90b is hydrogen, the chemical product during the electrical discharge machining process will not be hazardous gas but will be water instead. Likewise, when the second phase flow is ammonia, the chemical product during the electrical discharge machining process will not be hazardous gas but will be water and nitrogen instead. Accordingly, the hydrogen and ammonia can be the preferred choice for second phase flow.

Please refer to FIG. 2B, which illustrates the injection flow generating device according to another embodiment of the present invention. In the present embodiment, the injection flow generating device 2a is basically the same as the embodiment shown in FIG. 2A, but the different part is that the injection head 20 further comprises a first flow channel 202 communicated with the flow channel 201. The first flow channel 202 is configured to guide a second flow 91 flowing into the flow channel 201 so that the second flow 91 can be mixed with the first flow 90. In the present embodiment, the second flow 91 contains liquid 91a and a plurality of grinding particles 91b. In the present embodiment, the grinding particles 91b can be particles having nano scale or micro scale. Alternatively, the second flow 91 can be a mixture flow having bubbles and particles, wherein the contents of the mixture flow are disclosed in Japanese Publication No. S59-93239, which will not be further described hereinafter. In the embodiment shown in FIG. 2B, the second flow 91 is provided by liquid tank 4a, wherein a pumping device is operated to pump the second flow 91 to the nozzle 200 through pipelines. In the present embodiment, the flow that injected from the injection head 20 to the hollow channel 210 of the wire electrode 21 is a mixture of the first flow 90 and the second flow 91.

Please refer to FIG. 2C, which illustrates injection flow generating device according to another embodiment of the present invention. In the present embodiment, the injection flow generating device 2b is basically the same as the embodiment shown in FIG. 2B, but the different part of the injection head 20 further comprises a second flow channel 203 communicated with the flow channel 201. The second flow channel 203 guide a third flow 92 entering into the flow channel 201. In the present embodiment, the third flow 92 is air in the external environment surround the injection flow generating device 2b, wherein the air enters the flow channel 201 through the second flow channel 203. It is noted that, in one embodiment, the third flow 92 is not limited to the air. For example, the third flow 92 can also be specific gas, such as hydrogen, oxygen or other type of gas, entering the flow channel 201 through the second flow channel 203. In the present embodiment, the flow that injected from the injection head 20 to the hollow channel 210 of the wire electrode 21 is a mixture of the first flow 90, the second flow 91, and the third flow 92.

Please refer to FIG. 2D, which illustrates the injection flow generating device according to another embodiment of the present invention. In the present embodiment, it is further described the way for providing the first flow 90 shown in FIGS. 2A-2C. The first flow 90 is a mixture of liquid and gas, wherein the gas in the present embodiment is provided by an electrolysis device 5. In the present embodiment, the electrolysis device 5 comprises an anode 51 and cathode 52 wherein the anode 51 generates oxygen 90c during the electrolysis reaction, while the cathode 52 generates hydrogen 90d during the electrolysis. In the present embodiment, the first phase flow 90a is water accommodated in the reaction container 53. A central shaft of the electrolysis device 5 further comprises a guiding channel 54 for connecting with the pipeline 55 which is utilized to guide liquid pumped by the pumping device 56 from the liquid tank 4 to the reaction container 53 whereby the anode 51 and cathode 52 can perform electrolysis reaction. It is noted that the power supplied to the electrolysis device 5 can be a batter or supply mains electrically connected to the anode 51 and cathode 52. During the electrolysis reaction, the oxygen 90c generated from anode 51 is guided into the guide channel 54 and is mixed with the first phase flow 90a. Likewise, the hydrogen 90d generated from the cathode 52 is emitted into the first phase flow 90a in the reaction container 53.

In the present embodiment, a rotating element 59 is arranged at bottom of the reaction container 53. When the rotating element 59 is rotated at high speed, the liquid level is risen so that the first phase flow 90a containing hydrogen 90d and oxygen 90c can be drawn into the pipeline 55a through the operation of pumping device 58 and flows into the liquid tank 4 through the pipeline 55a. Accordingly, the oxygen 90c and hydrogen 90d can be contained in the first flow 90 stored in the liquid tank 4 after a period of reaction time. On the other hand, the first flow 90 stored in the liquid tank 4 can be drawn into the injection head 20 through the pipeline and pumping device 25. In order to supply the liquid, in one alternative embodiment, additional first phase flow 90a can be supplied into the liquid tank 4 through the pipeline 55b. The source of additional first phase flow 90a can be obtained according to the user's need without any limitation. For example, in one embodiment, the addition first phase flow 90a can be a recycled and filtered first phase flow 90a retrieved from the electrical discharge machining area.

Through the injection flow generating device 2a shown in FIGS. 2A to 2D, the gas phase and liquid phase can be mixed and injected into the hollow channel of the wire electrode 21 whereby the wire electrode 21 can effectively injected the flow into the machining area during the deep hole or tiny hole machining process so as to achieve lubricant effect and effect of discharging the machining debris or waste during the EDM processing. It is noted that, in the previous embodiment, the first flow can be an atomized flow or flow having micro scale or nano scale bubbles through adjusting the fraction ratio of gas phase and liquid phase whereby the injected flow can more smoothly passing through the tiny channel of the wire electrode so as to improve the machining efficiency.

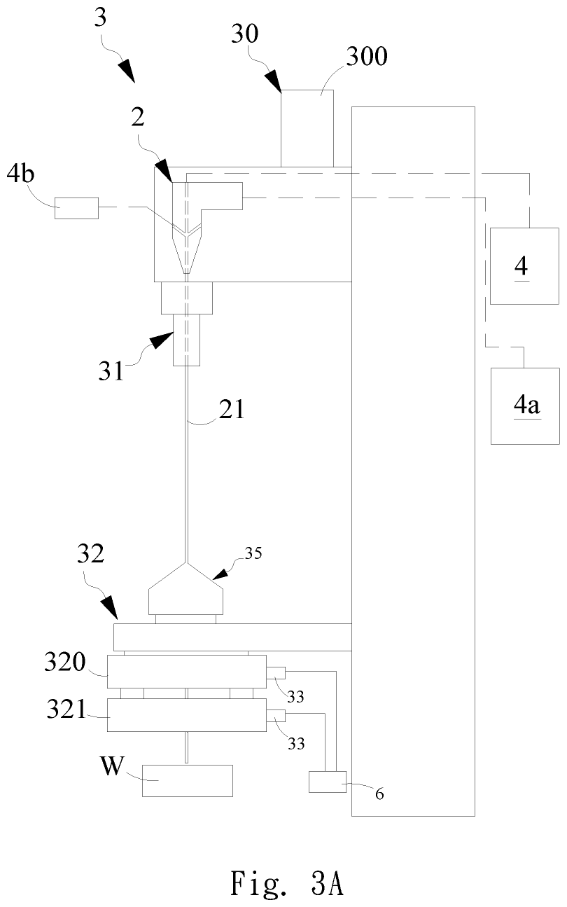

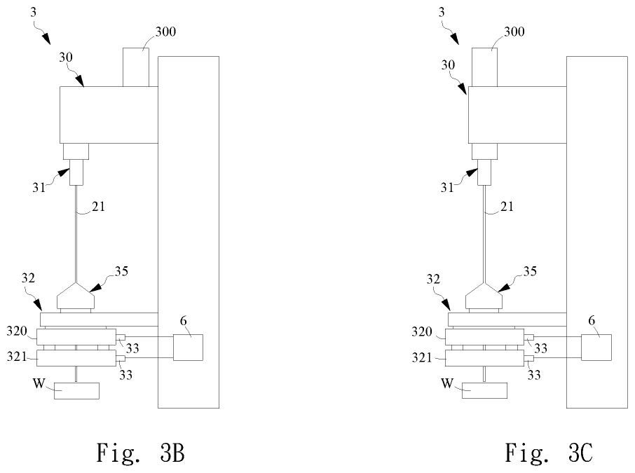

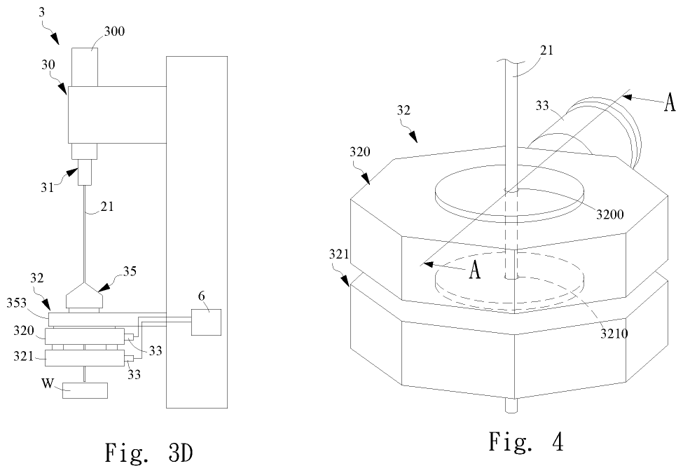

Please refer to FIG. 3A, which illustrates electrical discharge machining (EDM) device according to one embodiment of the present invention. In the present embodiment, the EDM device 3 can be, but should not be limited to, an EDM for machining tiny hole or deep hole. The EDM device 3 drives the wire electrode 21 to drill the object W. The EDM device 3 comprises an electrode clamping structure 31 and an electrode guiding device 32. The electrode clamping structure 31 is coupled to a driving module 30 of the EDM device 3. In the present embodiment, the driving module 30 comprises a driving device 300, such as motor, for example. The driving power generated from the driving device 300 is transmitted to the electrode clamping structure 31 through power transmission elements, such as belt, and gear, for example. The electrode clamping structure 31 is configured to clamping the wire electrode 21 and rotates the wire electrode 21 through the rotating power received from the driving device 300. The electrode guiding device 32 is arranged at one side of the electrode clamping device 31 for guiding the wire electrode 21. The wire electrode 21 is extended from the electrode clamping device 31 to the electrode guiding device 32.

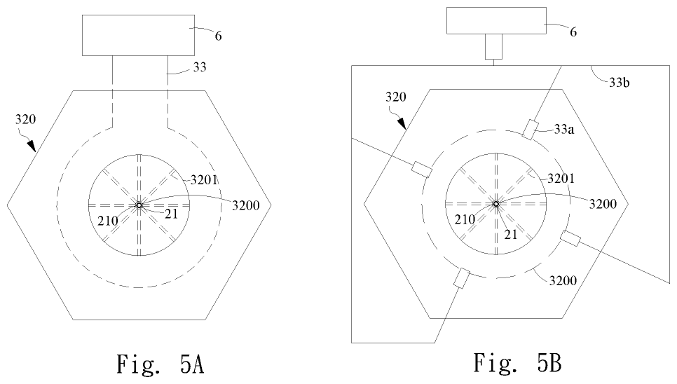

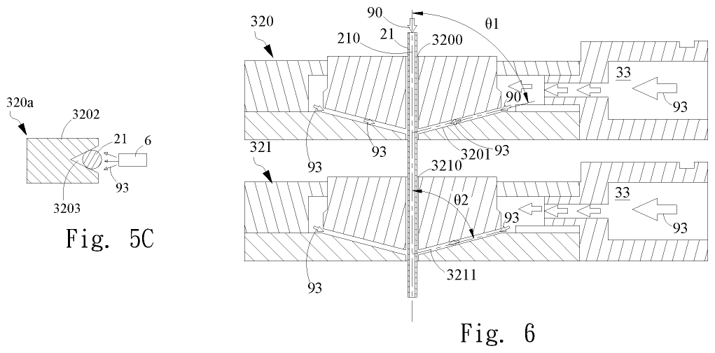

Please refer to FIGS. 4, 5A and 6, in which FIG. 4 illustrates one embodiment of the electrode guiding device of the present invention, FIG. 5A illustrates a top view of a first flow bearing according one embodiment of the present invention, and FIG. 6 illustrates AA cross sectional view of the electrode guiding device according to one embodiment of the present invention. In the present embodiment, the electrode guiding device 32 comprises a first flow bearing 320 and a second flow bearing 321. The first flow bearing 320 comprises a first through hole 3200 allowed the wire electrode 21 passing therethrough and a plurality of first branch channels 3201 communicated with the first through hole 3200 for guiding a buffer flow 93 acting on the wire electrode 21. In the present embodiment, there are eight first branch channels 3201 arranged inside the first flow bearing 320 and are equiangularly spaced around a center of the first through hole 3200. It is noted that it is not limited to eight first buffer channels 3201 in the present embodiment, and the quantities can be determined according to the user requirement. The plurality of first buffer channels 3201 is communicated with an inlet channel 33 guiding buffer flow 93 provided by the flow source 6.

The second flow bearing 321 is arranged at one side of the first flow bearing 320. The second flow bearing 321 has a second through hole 3210 corresponding to the first through hole 3200 allowing the wire electrode 21 passing therethrough. The second flow bearing 321 further comprises a plurality of second buffer channels communicated with the second through hole 3210 for guiding the buffer flow 93 acting on the wire electrode 21. In the present embodiment, the structure of the second flow bearing 321 can be the same as the structure of the first flow bearing 320 or be different from the structure of the first flow baring 320, and the different part will be further described hereinafter. It is noted that the common flow source can be utilized to provide flow to the first and second flow bearings 320 and 321 or separated flow sources can be utilized to provide flow to the first and second flow bearings 320 and 321. According to the embodiment shown in FIG. 3A, the flow source 6 is commonly used by the first and the second flow bearings 320 and 321.

A channel central axis of each first branch channel 3201 has a first included angle θ1 with the wire electrode 21 and a channel central axis of each second branch channel 3211 has a second included angle θ2. The wire electrode 21, in this embodiment, is an electrode having the hollow channel 210 for providing the first flow 90, the first and second flows 90 and 91, or the first, second, and third flows 90˜92. The first angle θ1 or the second angle θ2 can be smaller than 90 degree or larger than 90 degree.

It is noted that the first flow bearing is not limited to the embodiment shown in FIG. 5A. Alternatively, in the embodiment, please refer to FIG. 5B which illustrates a top view of first flow bearing according to another embodiment of the present invention. Basically the embodiment shown in FIG. 5B is similar to the embodiment shown in FIG. 5A, the different part is that the first flow bearing 320 has a plurality of inlet channels 33a. In the present embodiment, there are four inlet channels 33a equiangularly spaced and arranged in the body of the flow bearing 320. In the present of embodiment, the flow provided by the flow source 6 are guided to the four inlet channels 33a respectively arranged between two first branch channels 3201 through gas pipelines 33b. The flow is exhausted from the inlet channels 33a and enters the first branch channels 3201. It is noted that since there are a plurality of inlet channels 33a equiangularly arranged the first flow bearing 320, the flow pressure of the flow from the flow source 6 can be evenly distributed to each branch channel 3201 whereby the outer surface of wire electrode 21 can evenly receive the reaction force from the flow acting thereon thereby keeping the position of the wire electrode 21 stable without shifting the position of the wire electrode 21 along the radial direction so as to maintain the wire electrode 21 stably arranged along the axial direction and ensure the machining precision.

In addition, please refer to FIG. 5C, which illustrates another first flow bearing according to another embodiment of the present invention. In the present embodiment, the first flow bearing 320a comprises a blocking structure 3202 having a groove structure 3203. In the present embodiment, the groove structure 3202 is a V shaped structure for accommodating the wire electrode 21. At another side of the blocking structure 3202, a buffer flow 93 provided by the flow source 6 acts onto the wire electrode 21 thereby forcing the wire electrode to contact with the surface of the groove structure 3203. Since the flowing direction of the buffer flow 93 is toward the wire electrode 21 for constraining the wire electrode 21 in the groove structure 3202, it is capable of ensuring the wire electrode 21 rotating along the axial direction of wire electrode 21 during the machining process whereby the wire the electrode will not shift along the redial direction thereby ensuring the machining precision.

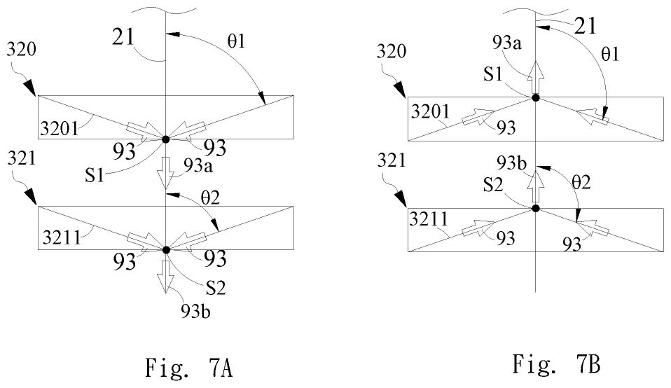

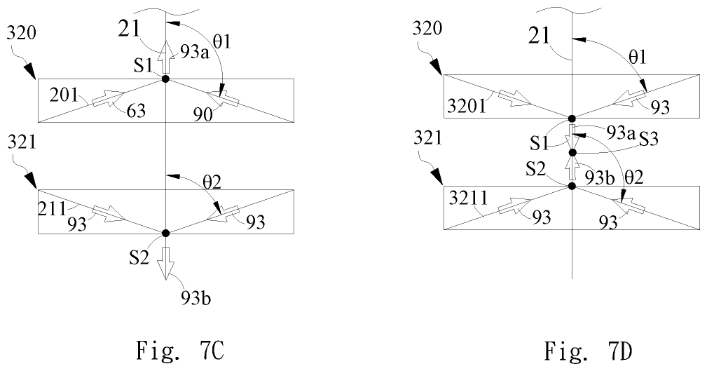

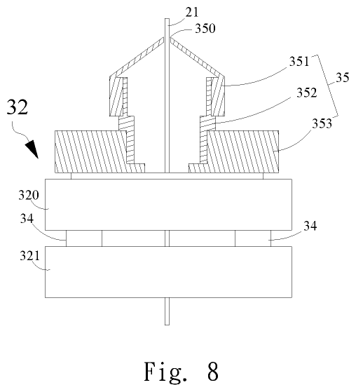

Please refer to FIGS. 7A-7D, which respectively illustrate an arrangement of the first guiding channel and the second guiding channel in the first and second flow bearings according one embodiment of the present invention. In the embodiment shown in FIG. 7A, the first guiding channel 3201 in the first flow bearing 320 has a first included angle θ1 and the second guiding channel 3211 in the second flow bearing 321 has a second included angle θ2 are smaller than 90 degree, and the first included angle θ1 and the second included angle θ2 can be the same as each other or different from each other. In the first flow bearing 320, the buffer flow 93 flows in each first guiding channel 3201 and is converged into a converged flow 93a having downward flowing direction while, in the second flow bearing 321, the buffer flow 93 flows in each second guiding channel 3211 and is converged into a converged flow 93b having downward flowing direction. In FIG. 7A, the notation S1 represents a contact position between the wire electrode 21 and buffer flow 93 flowing along the first guiding channel 3201, and the contact position constitutes a first supporting point for supporting the wire electrode 21. The notation S2 represents a contact position between the wire electrode 21 and buffer flow 93 flowing along the second guiding channel 3211, and the contact position constitutes a second supporting point for supporting the wire electrode 21.

In the embodiment shown in FIG. 7B, the first included angle θ1 of the first guiding channel 3201 of the first flow bearing 320 and the second included angle θ2 of the first guiding channel 3211 of the first flow bearing 321 can be larger than the 90 degrees and can be the same as each other or different from each other. In the first flow bearing 320, the buffer flow 93 flows in each first guiding channel 3201 and is converged into a converged flow 93a having upward flowing direction while, in the second flow bearing 321, the buffer flow 93 flows in each second guiding channel 3211 and is converged into a converged flow 93b having upward flowing direction. In FIG. 7B, the notation S1 represents a contact position between the wire electrode 21 and buffer flow 93 flowing along the first guiding channel 3201, and the contact position constitutes a first supporting point for supporting the wire electrode 21. The notation S2 represents a contact position between the wire electrode 21 and buffer flow 93 flowing along the second guiding channel 3211, and the contact position constitutes a second supporting point for supporting the wire electrode 21.

In the embodiment shown in FIG. 7C, the first included angle θ1 of the first guiding channel 3201 of the first flow bearing 320 is larger than the 90 degrees and the second included angle θ2 of the second guiding channel 3211 of the second flow bearing 321 is smaller than the 90 degrees. In the first flow bearing 320, the buffer flow 93 flows in each first guiding channel 3201 and is converged into a converged flow 93a having upward flowing direction while, in the second flow bearing 321, the buffer flow 93 flows in each second guiding channel 3211 and is converged into a converged flow 93b having downward flowing direction. In FIG. 7C, the notation S1 represents a contact position between the wire electrode 21 and buffer flow 93 flowing along the first guiding channel 3201, and the contact position constitutes a first supporting point for supporting the wire electrode 21. The notation S2 represents a contact position between the wire electrode 21 and buffer flow 93 flowing along the second guiding channel 3211, and the contact position constitutes a second supporting point for supporting the wire electrode 21.

In the embodiment shown in FIG. 7D, the first included angle θ1 of the first guiding channel 3201 of the first flow bearing 320 is smaller than the 90 degrees and the second included angle θ2 of the second guiding channel 3211 of the second flow bearing 321 is larger than the 90 degrees. In the first flow bearing 320, the buffer flow 93 flows in each first guiding channel 3201 and is converged into a converged flow 93a having downward flowing direction while, in the second flow bearing 321, the buffer flow 93 flows in each second guiding channel 3211 and is converged into a converged flow 93b having upward flowing direction. In FIG. 7D, the notation S1 represents a contact position between the wire electrode 21 and buffer flow 93 flowing along the first guiding channel 3201, and the contact position constitutes a first supporting point for supporting the wire electrode 21. The notation S2 represents a contact position between the wire electrode 21 and buffer flow 93 flowing along the second guiding channel 3211, and the contact position constitutes a second supporting point for supporting the wire electrode 21. It is noted that the converged flowing direction of converged flows 93a and 93b shown in FIGS. 7A˜7C are different from each other while the converged flowing direction of converged flows 93a and 93b shown in FIG. 7D is opposite to each other such that the converged flows 93a and 93b can be collided to each other and the collided position forms a third supporting point for generating an action force acting onto the wire electrode 21.

Please refer to the FIG. 8, which illustrates a cross sectional view of the flow conducting device according to one embodiment of the present invention. In the embodiment shown in FIG. 8, a plurality of supporting elements 34 are arranged between the first flow bearing 320 and the second flow bearing 321so as to keep the first flow bearing 320 an interval away from the second flow bearing 321. In one embodiment, the interval can form an emitting space for the flow injected from the first flow bearing 320 or second flow bearing 321. The electrode guiding device 32 further comprises a flow conducting device 35 arranged at another side of the first flow bearing 320 such that the first flow bearing 320 is arranged between the second flow bearing 321 and the flow conducting device 35. The flow conducting device 35 further comprises third through hole 350 corresponding to the first through hole 3200. The wire electrode 21 further passes through the third through hole 350. In the present embodiment, the flow conducting device 35 further comprises a supporting base 351, a conducting pipe 352 and a connecting element 353. The supporting base 351 is disposed on the first flow bearing 320 while the connecting element353 is utilized to connect the conducting pipe 352 on the supporting base 351. In the present embodiment, two supporting point formed by the injected flow from the first and the second branch channels 3201 and 3211 respectively formed inside the first flow bearing 320 and the second flow bearing 321 can suppress the vibration of the wire electrode 21. Moreover, since the wire electrode 21 is extended upwardly out of the third through hole 350 and to the location where the wire electrode is clamped, the axial distance between the electrode clamping structure 31 and the electrode guiding device 32 is very long such that the wire electrode 21 vibrates rapidly during the machining process. Therefore, through the injected flow guided by the flow conducting device 35 upwardly flowing toward the wire electrode 21, the wire electrode 21 can be more stably operated without vibration.

Please refer to the FIG. 3B. In the embodiment shown in FIG. 3B, basically, it is similar to the embodiment shown in FIG. 3A. The different part is that the flow source 6 is arranged inside the EDM device 3 rather than being arranged outside the EDM device 3 shown in FIG. 3A. Alternatively, in the embodiment shown in FIG. 3C, basically, it is similar to the embodiment shown in FIG. 3B. The different part is that the output shaft of driving device 300, such as the motor, of the driving module 3 is directly coupled to the electrode clamping structure 31 for directly rotating the electrode clamping structure 31. Please refer to FIG. 3D. Basically, the embodiment shown in FIG. 3C is similar to the embodiment shown in FIG. 3D, and the different part is that the flow source 6 is arranged inside the EDM device 3 and the pipeline is coupled to the inlet channel 33 of the first bearing 320 and the second bearing 321 through connecting element 353. In addition, it is noted that although the components of EDM device for tiny hole or deep hole such as power supply, structural body or the driving device for driving the supporting platform, for example, are not illustrated in the embodiments shown in the figures, those elements are well known by the one having ordinary skilled in the arts; therefore the detail will not be described hereinafter.

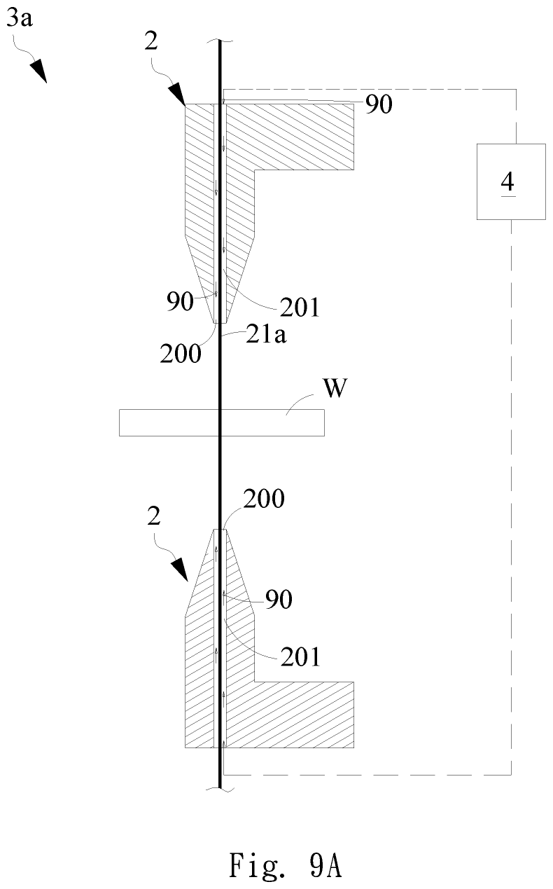

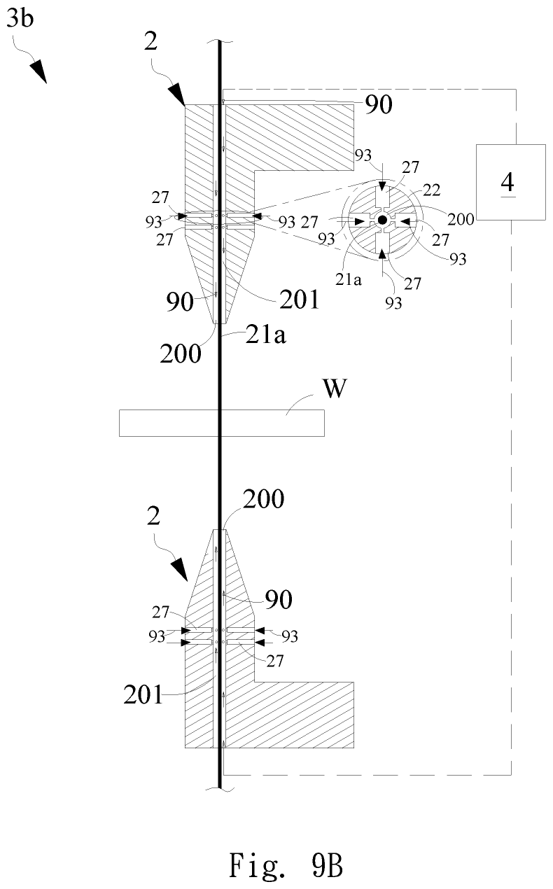

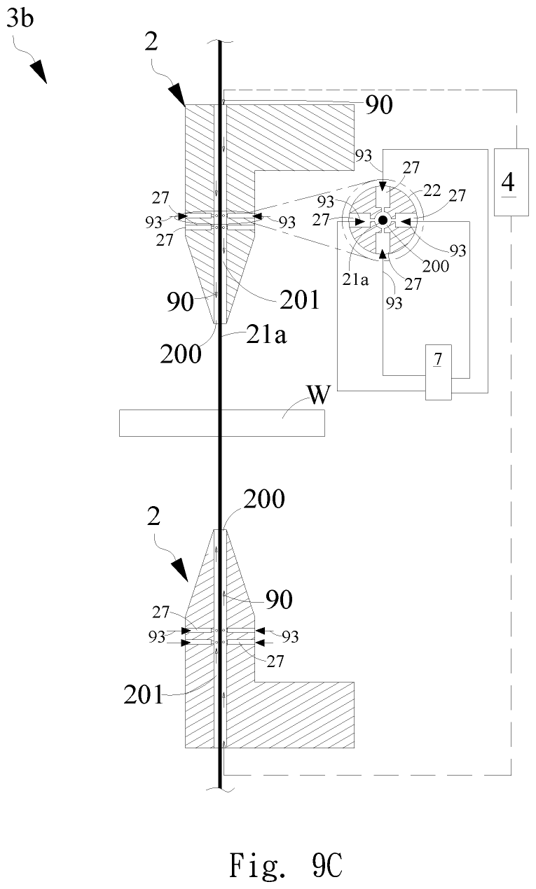

Please refer to FIG. 9A, which illustrates an EDM device having injection flow generating device according to one embodiment of the present invention. In the present embodiment, the EDM device 3a is a wire cutting EDM device having a pair of injection flow generating devices 2 opposite to each other. In the present embodiment, the injection flow generating device 2 comprises a wire electrode 21a extending outwardly outside the nozzle 200 for performing EDM process to the object W. In the present embodiment, the wire electrode 21a is a solid wire electrode. The wire electrode 21a receives a first flow 90 injected from the nozzle 200. In the present embodiment, the wire electrode 21a passes through the nozzle such that the first flow 90 covers the peripheral surface of the wire electrode 21a. The first flow 90 is provided to the two opposite injection flow generating devices 2 from the liquid tank 4. The first flow 90, in the present embodiment, has gas and liquid mixed with other for achieving objectives of discharging the machining debris and lubricant effects during the EDM cutting process. In addition, the first flow 90 can further contains a flammable gas, combustion gas, or a combination of the flammable gas and the combustion gas whereby the gas can be burned during the EDM process. The heat generated by the burning of the flammable gas or combustion gas can further improve the cutting efficiency thereby assisting the wire cutting process.

Please refer to FIG. 9B, in which the EDM device 3b is basically the same as the embodiment shown in FIG. 9A whereas the different part is that the injection flow generating device 2 further comprises a plurality buffer channels 27 respectively communicated with the flow channel 201 wherein each buffer channel 27 also communicated with the external environment. In the present embodiment, since the first flow 90 is injected with high flowing speed in the flow channel 201, the pressure of the first flow in the central axis of the flow channel 201 is lower than the pressure at the outer surface of the injection flow generating device 2. Therefore, when the first flow 90 is injected from the nozzle 200 with high flowing speed, the negative pressure is generated around the central axis of the flow channel 201 simultaneously whereby the gas in the external environment are suck into the plurality of buffer channels 27 thereby forming buffer gas 93. After the buffer gas 93 are suck into the buffer channels 27, the buffer gas 93 are exhausted into the flow channel 201 and generates an reaction force acting onto the wire electrode 21 arranged inside the flow channel 201. Since the plurality of buffer channels 27 are symmetrically and peripherally arranged around the injection flow generating device 2, the reaction forces generated by the buffer gas 93 are also symmetrically and evenly acted on the wire electrode 21 such that the wire electrode 21 are maintained in the central position without shifting and vibrating under the action of the buffer gas 93 around the wire electrode 21. Therefore the wire electrode 21 can be kept in the central position during the EDM process so as to improve the machining precision. It is noted that although the gas is naturally suck into the injection flow generating device by the negative pressure in the embodiment shown in FIG. 9B, alternatively, in the embodiment shown in FIG. 9C, gas providing source 7 can be communicated with each buffer channel 27 through pipelines for actively providing gas into the buffer channel 27.

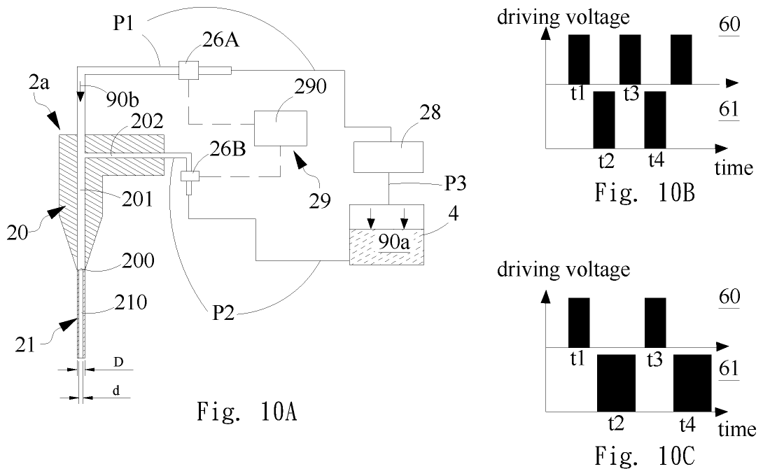

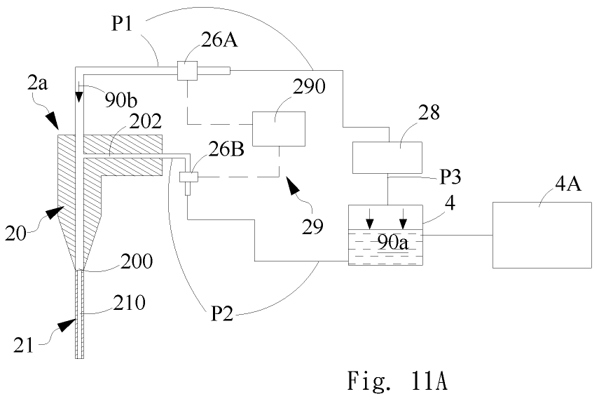

Please refer to FIGS. 10A-10C, in which FIG. 10A illustrates injection flow generating device according to one embodiment of the present invention, while FIGS. 10B-10C illustrates controlling signal for operating the injecting head. In the embodiment shown in FIG. 10A, the injection flow generating device 2a further comprises flow control system 29 for controlling the first phase flow 90a and second phase flow 90b flowing into the injection head 20. In the embodiment shown in FIG. 10A, the injection head 20 further comprises flow channel 201 and first flow channel 202 wherein one end of the flow channel 201 is connected to the wire electrode 21 having hollow channel 210. The outer diameter of the wire electrode 21 is ranged between 0.1 mm˜1 mm while the inner diameter of the wire electrode 21 is ranged between 0.03 mm˜0.4 mm. It is noted that the size of the wire electrode 21 is determined according to the machining requirement and it is not limited by the range disclosed in the present embodiment. The other end of the flow channel 201 is communicated with the first pipeline P1 and gas providing device 28, which is an air pump, in the present embodiment. In the present embodiment, the gas providing device 28 is communicated with the liquid tank 4 through a pipeline P3 for providing the second phase flow 90b to the liquid tank 4. The second phase flow 90b is gas in the present embodiment. By means of providing the high pressure acting onto the liquid surface of the liquid tank 4, such that the first phase flow 90a is forced into the second pipeline P2 and enters into the first channel 202. In the first pipeline P1, it further comprises a first control valve 26A for controlling the amount of the gas provided from the gas providing device 28 entering to the injecting head 20 through the first pipeline P1. One end of the first flow channel 202 is communicated with the first channel 202 and the other end is communicated with liquid tank 4 through the second pipeline P2. The first phase flow 90a accommodated in the liquid tank 4 flows into the first channel 202 and the second pipeline P2. The second pipeline P2 further comprises a second control valve 26B for controlling the amount of the flow entering the first flow channel 202. It is noted that the control valves 26A and 26B can be electrical control valve or gas-actuated control valve. In the embodiment described below, the electrical control valve is utilized as an embodiment of the control valves 26A and 26B.

Since the dimension of inner diameter is vary small, e.g. ranged between 0.03 mm˜0.4 mm, the mixed gas-liquid phase flow comprising first phase flow 90a and the second phase flow 90b cannot easily pass through the hollow channel 210 inside the wire electrode 21. Without the effectively control measure, the problem that the first phase flow 90a and the second phase flow 90b inversely flow back may be occurred. In order to ensure the first phase flow 90a and the second phase flow 90b to pass through the hollow channel 210 smoothly and effectively without generating inversely flow in the hollow channel 210. In the present embodiment shown in FIG. 10B, the control module 290 alternately actuates the first control vale 26A and the second control valve 26B so that the liquid phase flow and gas phase flow can be effectively mixed inside the injection head 20 and the mixed flow can smoothly pass through the hollow channel 210 of the wire electrode 21. In FIG. 10B, the area 60 represents a relation of driving voltage versus time for controlling the first control valve 26A while the area 61 represents a relation of driving voltage versus time for controlling the second control valve 26B. It is noted that the driving voltage is provided to open first control valve 26A for a time interval t1 and then is switched OFF to close the first control valve 26A. During the time interval t1, since the first control valve 26A is opened, the second phase flow 90b, i.e. high pressure gas, supplied by the gas providing device 28 enters into the injection head 20 through the first pipeline P1.

After the time interval t1, the first control valve 26A is closed while the second control valve 26B is opened for a second time interval t2. During the time interval t2, the first phase flow 90a in the liquid tank 4 flows into the first channel 202 through the first pipeline, and enters the injection head 20 so as to mix with the second phase flow 90b thereby forming a gas-liquid mixed flow having micro bubbles contained therein. After the time interval t2, the second control valve 26B is closed and then the first control valve 26A is driven to open for a third time interval t3. During the third time interval t3 that the first control vale 26A is opened, the second phase flow 90b enters into the injection head 20. Since the second control valve 26B is closed at the time interval t2, the mixed flow inside the injection head 20 are pushed into the hollow channel 210 of the wire electrode 21 by the high-pressured second phase flow 90b and is injected out of the hollow channel 210 of wire electrode 21. Due to the alternately opening the first control valve 26A and closing second control valve 26B as well as closing the first control valve 26A and opening the second control valve 26B, the mixed flow inside the injection head 20 can pass through the hollow channel 210 of the wire electrode 21 smoothly thereby preventing the problem that the mixed flow inversely flowing back due to the small diameter from being occurred and allowing the injection of the mixed gas-liquid flow from the hollow channel 210 more smoothly and effectively.

Alternatively, in one embodiment shown in FIG. 10C, the control measure shown in FIG. 10C is similar to the control measure shown in FIG. 10B but the different part is that the timing point to open the first control valve 26A and second control valve 26B is different from each other. In the embodiment shown in FIG. 10C, the time interval for opening the second control valve 26B is longer than the time interval for opening the first control valve 26A. It is noted that the length of time interval for opening the control valve 26A or 26B is determined according to the user's requirement, which is not limited by the illustration shown in the FIG. 10B or 10C.

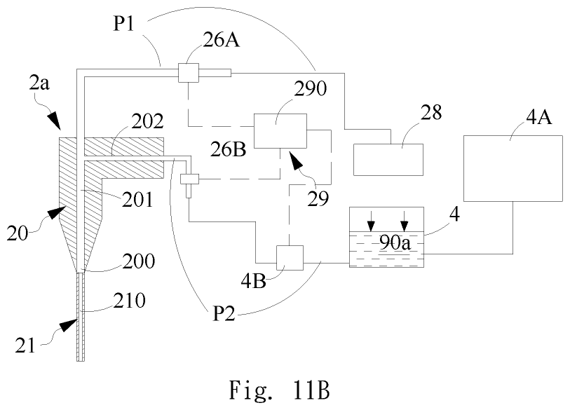

Please refer to FIGS. 11A and 11B, which respectively illustrate injection flow generating device according to different embodiments of the present invention. In the embodiment shown in FIG. 11A, basically it is similar to the embodiment shown in FIG. 10A, but the different part is that the liquid tank 4 of the present embodiment further connects to a liquid supply system 4A for supplying the first phase flow 90a to the liquid tank 4. In the embodiment shown in FIG. 11B, the different part is that the gas providing device 28 is not connected to the liquid tank 4 to supply gas pressure. Alternatively, a pump 4B connected to the second pipeline P2 is adapted. The first phase flow 90a is pumped out of the liquid tank 4 by the pump 4B controlled by the control module 290 and then enters into the second flow channel 202.

According to the embodiments described above, the injection flow generating device injects mixed flow having the liquid phase and gas phase flow into the wire electrode such that the wire electrode can effectively injected the mixed flow into the machining location for achieving the effects of discharging debris and improving the lubrication during the deep hole or tiny hole machining process. In addition, the double layers arrangement of flow bearing is further arranged in the EDM device of the present embodiment, in which the radially disposed guiding channels having specific angle arrangement are utilized to form a combined flow, e.g. injected upwardly or downwardly, for suppressing the vibration of the wire electrode, whereby the rotating wire electrode would not contact with the electrode guiding structure so that the issues of abrasion and vibration can be reduced thereby achieving effects of improving machining precision and efficiency, and reducing the abrasion of wire electrode and electrode guiding structure. Moreover, with the arrangement of the flow bearing, the electrode guiding structure is not necessary to be changed when machining the tiny hole or deep hole having different dimension, because the through hole of the electrode guiding structure can be larger than the conventional arts under the assistance of double layered flow bearings so that the suppression of electrode vibration can be efficiently provided under various electrode having different diameter dimension and the automatically machining can be maintained to keep machining efficiency because the shut-down of EDM device due to manually changed diamond dies can be prevented.

While the present invention has been particularly shown and described with reference to a preferred embodiment, it will be understood by those skilled in the art that various changes in form and detail may be without departing from the spirit and scope of the present invention.

What is claimed is:

1. An electrical discharge machining device, comprising:
a first injection flow generating device, comprising an injection head having a nozzle and a flow channel communicated with the nozzle, wherein the flow channel is utilized to guide a first flow injected from the nozzle, wherein the first flow comprises a first phase flow and a second phase flow; and
a wire electrode, coupled to the nozzle for receiving the first flow injected from the nozzle.

2. The device of claim 1, wherein the first flow is a liquid flow having a plurality of micro bubbles contained therein, and the first phase flow is a liquid, and the second phase flow is gas, wherein volume fraction of the first phase flow is 90˜95% while the volume fraction of the second phase flow is 5˜10%.

3. The device of claim 2, wherein the gas comprises a flammable gas, combustion gas, or a combination of the flammable gas and the combustion gas.

4. The device of claim 1, wherein the first flow is an atomized flow and the first phase flow is a liquid, and the second phase flow is gas, wherein volume fraction of the first phase flow is 5˜10% while the volume fraction of the second phase flow is 90˜95%.

5. The device of claim 4, wherein the gas comprises a flammable gas, combustion gas, or a combination of the flammable gas and the combustion gas.

6. The device of claim 1, wherein the injection head further comprising a first flow channel communicated with the flow channel, wherein a second flow flowing inside the first flow channel contains a plurality of grinding particles and the second flow is guided to enter the flow channel so as to mix with the first flow.

7. The device of claim 1, wherein the injection head further comprising a second flow channel communicated with the flow channel for guiding a gas into the flow channel.

8. The device of claim 1, wherein the wire electrode further comprises a hollow channel for guiding the first flow injected from the nozzle.

9. The device of claim 1, further comprising an electrode guiding device comprising a first flow bearing allowing the wire electrode to pass a center of the first flow bearing and the first flow bearing further comprising a plurality of first guiding channel peripherally arranged around the wire electrode, wherein a gas inlet channel is arranged between at least two adjacent first guiding channels for communicating with the adjacent first guiding channel.

10. The device of claim 1, further comprising an electrode guiding device comprising a first flow bearing comprising a blocking structure wherein a groove structure is formed at a lateral side of the blocking structure for accommodating the wire electrode and a flow source is arranged at one side of the blocking structure for providing a buffer flow acting on the wire electrode such that a surface of the wire electrode is contacted with the groove structure.

11. The device of claim 1, further comprising:
an electrode clamping structure, configured to clamp the wire electrode and to rotate the wire electrode; and
an electrode guiding device, arranged at one side of the electrode clamping structure for guiding the wire electrode.

12. The device of claim 1, further comprising a second injection flow generating device arranged opposite to the first injection flow generating device.

13. The device of claim 12, wherein the wire electrode is a solid wire electrode for receiving the first flow injected from the nozzle, and the wire electrode passes through the nozzle such that a peripheral surface of the wire electrode is covered by the first slow.

14. The device of claim 12, wherein the first injection flow generating device further comprises a plurality of buffer channels respectively communicated with the flow channel and an external environment outside the first injection flow generating device.

15. The device of claim 14, wherein each buffer channel is coupled to a gas source for receiving buffer gas from the gas source.

16. The device of claim 1, further comprising a flow controlling system and the injection head further comprising a first flow channel communicated with the flow channel, the flow controlling system further comprising:
a liquid tank, configured to accommodate the first phase flow;
a first pipeline, configured to communicate with the flow channel, the first pipeline further comprising a first control valve;
a gas source, configured to connect with the first control valve for providing the second phase flow;
a second pipeline, configured to have a first end communicated with the first flow channel and a second end communicated with the liquid tank, the second pipeline further comprising a second control valve; and
a control module, configured to couple to the first control valve and the second control valve.

17. The device of claim 16, wherein the gas source further communicates with the liquid tank for providing the second phase flow into the liquid tank.

18. The device of claim 16, wherein the second pipeline further comprises a pump communicated with the liquid tank for pumping the first phase flow stored in the liquid tank into the first flow channel.

19. The device of claim 16, wherein the first control valve and the second control valve are alternately switched on-off by the control module.
